(19) United States
(12) Patent Application Publication
(10) Pub. No.: US 2026/0231073 A1
(43) Pub. Date: Aug. 6, 2026

(54) APPARATUS, METHOD, AND COMPUTER PROGRAM

(71) Applicant: Nokia Technologies Oy, Espoo (FI)

(72) Inventors: Halit Murat GÜRSU, Munich (DE); Ahmad AWADA, Munich (DE); Panagiotis SPAPIS, Munich (DE); Umur KARABULUT, Munich (DE); Srinivasan SELVAGANAPATHY, Bangalore (IN); Ali KARIMIDEHKORDI, Munich (DE); Sanjay GOYAL, Murray Hill, NJ (US); Timo KOSKELA, Oulu (FI); Anastasios KAKKAVAS, Munich (DE)

(21) Appl. No.: 19/154,851

(22) PCT Filed: Feb. 29, 2024
(86) PCT No.: PCT/EP2024/055236

§ 371 Date: Aug. 8, 2025

(30) Foreign Application Priority Data
Apr. 5, 2023 (IN) 202341025740

(51) Int. Cl. H04W 56/00; H04W 24/10; H04W 36/24

(52) U.S. Cl. CPC H04W 56/0045; H04W 24/10; H04W 36/249

(57) ABSTRACT

There is provided a method, computer program, and apparatus for a user equipment, that causes the user equipment to perform: signalling a measurement report to a first network access node via a first cell, the measurement report comprising an indication of a signal quality associated with a second cell provided by a second access network node; receiving an instruction to connect to the second cell, the second cell being provided by a second network access node, wherein the instruction indicates whether the user equipment is to connect to the second cell with or without obtaining a new timing advance value; and connecting to the second cell in accordance with the received instruction.

### FIELD OF THE DISCLOSURE

The examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided an apparatus for a first access network node, the apparatus comprising means for: receiving, from the user equipment via a first cell provided by the first access network node, a measurement report comprising an indication of a signal quality associated with a second cell provided by a second access network node; determining, based on the measurement report, to instruct the user equipment to connect to the second cell; determining whether a second timing advance value associated with the second access network node is valid; determining whether to instruct the user equipment to connect to the second cell without obtaining a new timing advance value for the second access network node when the second timing advance value is determined to be valid, or to instruct the user equipment to connect to the second cell with obtaining a new timing advance value when the second timing advance value is determined to be invalid; and instructing the user equipment in accordance with the determining whether to instruct.

The determining whether the second timing advance value is valid may comprise means for: receiving, from the user equipment, a second timing advance group identifier with the indication of the signal quality associated with the second cell, the second timing advance group identifier being associated with a second set of cells having a same second timing advance value, the second set of cells comprising the second cell; and determining whether the second timing advance value is valid using the second timing advance group identifier.

The determining that the second timing advance value is valid may comprise means for: receiving, from the user equipment, an indication of whether the second timing advance group identifier is valid; and determining whether the second timing advance value is valid using the received indication of whether the second timing advance group identifier is valid.

The determining whether the second timing advance value is valid may comprise means for: receiving, from another network node, a second timing advance group identifier and an indication of a duration of time for which the second timing advance value is valid, the second timing advance group identifier being associated with a second set of cells having a same second timing advance value, the second set of cells comprising the second cell; and using the duration of the time to determine whether the second timing value is valid.

The apparatus may comprise means for: initializing a timer using the indicated duration on receipt of the indication of the duration; and starting the timer.

The another network node may be the second access network node or the another network node may be a centralized unit.

The apparatus may comprise means for signalling an indication of the second timing advance value to the user equipment.

The first access network node may be associated with a first timing advance group identifier being associated with a first set of cells having a same first timing advance value, wherein the first set of cells comprises the first cell.

The connecting to the second cell may comprise switching from the first cell to the second cell.

The first cell may be a serving cell and the second cell may be a candidate cell.

The apparatus may comprise means for: providing a plurality of first cells; associating each of the plurality of first cells with a timing advance value for the user equipment; grouping the plurality of first cells into different groups such that each group is associated with a same timing advance value; and assigning each of the different groups a respective identifier.

The apparatus may comprise means for: signalling, to a centralized unit, a mapping that indicates a correspondence between a respective identifier and its associated timing advance value.

The apparatus may comprise means for: receiving, from the centralized unit, an instruction to change a respective identifier associated with a specified timing advance value; and changing the identifier associated with the specified timing advance value.

According to a second aspect, there is provided an apparatus for a network node, the apparatus comprising means for: determining a second timing advance group identifier that is associated with a second set of cells having a same second timing advance value, at least one cell of the second set of cells being provided by a second access network node; determining a duration of validity of the second timing advance value; and signalling the duration of validity to another network node.

The network node may be a centralized unit and the another network node may be a first access network node. The apparatus may comprise means for: configuring the second timing advance group identifier at a second access network node, and configuring a first timing advance group identifier at the first access network node, the first timing advance group identifier being associated with a first set of cells having a same first timing advance value, at least one cell of the first set of cells being provided by the first access network node.

The apparatus may comprise means for: receiving, from the second access network node, a mapping that indicates a correspondence between a respective identifier of a group of second cells provided by the second access network node and its associated timing advance value; receiving, from a first access network node, a mapping that indicates a correspondence between a respective identifier of a group of first cells provided by the first access network node and its associated timing advance value; determining whether the timing advance values received are the same; and instructing the first and/or second access network node to change its respective identifier to be identical with the respective identifier of the other access network node when the timing advance values are determined to be the same.

The network node may be a first access network node and the another network node may be a centralized unit.

The apparatus may comprise means for: signalling a first mapping to a user equipment, the first mapping associating a first cell provided by a first access network node to a first timing advance group identifier, the first timing advance group identifier being associated with a first set of cells having a same first timing advance value, the first set of cells comprising the first cell; and signalling a second mapping to the user equipment, the second mapping associating a second cell provided by the second access network node to a second timing advance group identifier, the second timing advance group identifier being associated with a second set of cells having a same second timing advance value, the second set of cells comprising the second cell.

The second set of cells may comprise a candidate cell.

According to a third aspect, there is provided an apparatus for a user equipment, the apparatus comprising means for: signalling a measurement report to a first network access node via a first cell, the measurement report comprising an indication of a signal quality associated with a second cell provided by a second access network node; receiving an instruction to connect to the second cell, the second cell being provided by a second network access node, wherein the instruction indicates whether the user equipment is to connect to the second cell with or without obtaining a new timing advance value; and connecting to the second cell in accordance with the received instruction.

The apparatus may comprise means for, signalling the indication of the signal quality associated with the second cell with a second timing advance group identifier, the second timing advance group identifier being associated with a second set of cells having a same second timing advance value, the second set of cells comprising the second cell.

The apparatus may comprise means for signalling an indication of whether that the second timing advance group identifier is valid with the measurement report.

The apparatus may comprise means for: receiving a first mapping, the first mapping associating the first cell to a first timing advance group identifier, the first timing advance group identifier being associated with a first set of cells having a same first timing advance value, the first set of cells comprising the first cell; and receiving a second mapping, the second mapping associating the second cell to a second timing advance group identifier, the second timing advance group identifier being associated with a second set of cells having a same second timing advance value, the second set of cells comprising the second cell.

The connecting to the second cell may comprise switching from the first cell to the second cell.

The first cell may be a serving cell and the second cell may be a candidate cell.

According to a fourth aspect, there is provided an apparatus for a first access network node, the apparatus comprising: at least one processor; and at least one memory comprising code that, when executed by the at least one processor, causes the apparatus to perform: receiving, from the user equipment via a first cell provided by the first access network node, a measurement report comprising an indication of a signal quality associated with a second cell provided by a second access network node; determining, based on the measurement report, to instruct the user equipment to connect to the second cell; determining whether a second timing advance value associated with the second access network node is valid; determining whether to instruct the user equipment to connect to the second cell without obtaining a new timing advance value for the second access network node when the second timing advance value is determined to be valid, or to instruct the user equipment to connect to the second cell with obtaining a new timing advance value when the second timing advance value is determined to be invalid; and instructing the user equipment in accordance with the determining whether to instruct.

The determining whether the second timing advance value is valid may comprise: receiving, from the user equipment, a second timing advance group identifier with the indication of the signal quality associated with the second cell, the second timing advance group identifier being associated with a second set of cells having a same second timing advance value, the second set of cells comprising the second cell; and determining whether the second timing advance value is valid using the second timing advance group identifier.

The determining that the second timing advance value is valid may comprise: receiving, from the user equipment, an indication of whether the second timing advance group identifier is valid; and determining whether the second timing advance value is valid using the received indication of whether the second timing advance group identifier is valid.

The determining whether the second timing advance value is valid may comprise: receiving, from another network node, a second timing advance group identifier and an indication of a duration of time for which the second timing advance value is valid, the second timing advance group identifier being associated with a second set of cells having a same second timing advance value, the second set of cells comprising the second cell; and using the duration of the time to determine whether the second timing value is valid.

The apparatus may be caused to perform: initializing a timer using the indicated duration on receipt of the indication of the duration; and starting the timer.

The another network node may be the second access network node or the another network node may be a centralized unit.

The apparatus may be caused to perform signalling an indication of the second timing advance value to the user equipment.

The first access network node may be associated with a first timing advance group identifier being associated with a first set of cells having a same first timing advance value, wherein the first set of cells comprises the first cell.

The connecting to the second cell may comprise switching from the first cell to the second cell.

The first cell may be a serving cell and the second cell may be a candidate cell.

The apparatus may be caused to perform: providing a plurality of first cells; associating each of the plurality of first cells with a timing advance value for the user equipment; grouping the plurality of first cells into different groups such that each group is associated with a same timing advance value; and assigning each of the different groups a respective identifier.

The apparatus may be caused to perform: signalling, to a centralized unit, a mapping that indicates a correspondence between a respective identifier and its associated timing advance value.

The apparatus may be caused to perform: receiving, from the centralized unit, an instruction to change a respective identifier associated with a specified timing advance value; and changing the identifier associated with the specified timing advance value.

According to a fifth aspect, there is provided an apparatus for a network node, the apparatus comprising: at least one processor; and at least one memory comprising code that, when executed by the at least one processor, causes the apparatus to perform: determining a second timing advance group identifier that is associated with a second set of cells having a same second timing advance value, at least one cell of the second set of cells being provided by a second access network node; determining a duration of validity of the second timing advance value; and signalling the duration of validity to another network node.

The network node may be a centralized unit and the another network node may be a first access network node. The apparatus may be caused to perform: configuring the second timing advance group identifier at a second access network node, and configuring a first timing advance group identifier at the first access network node, the first timing advance group identifier being associated with a first set of cells having a same first timing advance value, at least one cell of the first set of cells being provided by the first access network node.

The apparatus may be caused to perform: receiving, from the second access network node, a mapping that indicates a correspondence between a respective identifier of a group of second cells provided by the second access network node and its associated timing advance value; receiving, from a first access network node, a mapping that indicates a correspondence between a respective identifier of a group of first cells provided by the first access network node and its associated timing advance value; determining whether the timing advance values received are the same; and instructing the first and/or second access network node to change its respective identifier to be identical with the respective identifier of the other access network node when the timing advance values are determined to be the same.

The network node may be a first access network node and the another network node may be a centralized unit.

The apparatus may be caused to perform: signalling a first mapping to a user equipment, the first mapping associating a first cell provided by a first access network node to a first timing advance group identifier, the first timing advance group identifier being associated with a first set of cells having a same first timing advance value, the first set of cells comprising the first cell; and signalling a second mapping to the user equipment, the second mapping associating a second cell provided by the second access network node to a second timing advance group identifier, the second timing advance group identifier being associated with a second set of cells having a same second timing advance value, the second set of cells comprising the second cell.

The second set of cells may comprise a candidate cell.

According to a sixth aspect, there is provided an apparatus for a user equipment, the apparatus comprising: at least one processor; and at least one memory comprising code that, when executed by the at least one processor, causes the apparatus to perform: signalling a measurement report to a first network access node via a first cell, the measurement report comprising an indication of a signal quality associated with a second cell provided by a second access network node; receiving an instruction to connect to the second cell, the second cell being provided by a second network access node, wherein the instruction indicates whether the user equipment is to connect to the second cell with or without obtaining a new timing advance value; and connecting to the second cell in accordance with the received instruction.

The apparatus may be caused to perform, signalling the indication of the signal quality associated with the second cell with a second timing advance group identifier, the second timing advance group identifier being associated with a second set of cells having a same second timing advance value, the second set of cells comprising the second cell.

The apparatus may be caused to perform signalling an indication of whether that the second timing advance group identifier is valid with the measurement report.

The apparatus may be caused to perform: receiving a first mapping, the first mapping associating the first cell to a first timing advance group identifier, the first timing advance group identifier being associated with a first set of cells having a same first timing advance value, the first set of cells comprising the first cell; and receiving a second mapping, the second mapping associating the second cell to a second timing advance group identifier, the second timing advance group identifier being associated with a second set of cells having a same second timing advance value, the second set of cells comprising the second cell.

The connecting to the second cell may comprise switching from the first cell to the second cell.

The first cell may be a serving cell and the second cell may be a candidate cell.

According to a seventh aspect, there is provided a method for an apparatus for a first access network node, the method comprising: receiving, from the user equipment via a first cell provided by the first access network node, a measurement report comprising an indication of a signal quality associated with a second cell provided by a second access network node; determining, based on the measurement report, to instruct the user equipment to connect to the second cell; determining whether a second timing advance value associated with the second access network node is valid; determining whether to instruct the user equipment to connect to the second cell without obtaining a new timing advance value for the second access network node when the second timing advance value is determined to be valid, or to instruct the user equipment to connect to the second cell with obtaining a new timing advance value when the second timing advance value is determined to be invalid; and instructing the user equipment in accordance with the determining whether to instruct.

The determining whether the second timing advance value is valid may comprise: receiving, from the user equipment, a second timing advance group identifier with the indication of the signal quality associated with the second cell, the second timing advance group identifier being associated with a second set of cells having a same second timing advance value, the second set of cells comprising the second cell; and determining whether the second timing advance value is valid using the second timing advance group identifier.

The determining that the second timing advance value is valid may comprise: receiving, from the user equipment, an indication of whether the second timing advance group identifier is valid; and determining whether the second timing advance value is valid using the received indication of whether the second timing advance group identifier is valid.

The determining whether the second timing advance value is valid may comprise: receiving, from another network node, a second timing advance group identifier and an indication of a duration of time for which the second timing advance value is valid, the second timing advance group identifier being associated with a second set of cells having a same second timing advance value, the second set of cells comprising the second cell; and using the duration of the time to determine whether the second timing value is valid.

The method may comprise: initializing a timer using the indicated duration on receipt of the indication of the duration; and starting the timer.

The another network node may be the second access network node or the another network node may be a centralized unit.

The method may comprise signalling an indication of the second timing advance value to the user equipment.

The first access network node may be associated with a first timing advance group identifier being associated with a first set of cells having a same first timing advance value, wherein the first set of cells comprises the first cell.

The connecting to the second cell may comprise switching from the first cell to the second cell.

The first cell may be a serving cell and the second cell may be a candidate cell.

The method may comprise: providing a plurality of first cells; associating each of the plurality of first cells with a timing advance value for the user equipment; grouping the plurality of first cells into different groups such that each group is associated with a same timing advance value; and assigning each of the different groups a respective identifier.

The method may comprise: signalling, to a centralized unit, a mapping that indicates a correspondence between a respective identifier and its associated timing advance value.

The method may comprise: receiving, from the centralized unit, an instruction to change a respective identifier associated with a specified timing advance value; and changing the identifier associated with the specified timing advance value.

According to an eighth aspect, there is provided a method for an apparatus for a network node, the method comprising: determining a second timing advance group identifier that is associated with a second set of cells having a same second timing advance value, at least one cell of the second set of cells being provided by a second access network node; determining a duration of validity of the second timing advance value; and signalling the duration of validity to another network node.

The network node may be a centralized unit and the another network node may be a first access network node. The method may comprise: configuring the second timing advance group identifier at a second access network node, and configuring a first timing advance group identifier at the first access network node, the first timing advance group identifier being associated with a first set of cells having a same first timing advance value, at least one cell of the first set of cells being provided by the first access network node.

The method may comprise: receiving, from the second access network node, a mapping that indicates a correspondence between a respective identifier of a group of second cells provided by the second access network node and its associated timing advance value; receiving, from a first access network node, a mapping that indicates a correspondence between a respective identifier of a group of first cells provided by the first access network node and its associated timing advance value; determining whether the timing advance values received are the same; and instructing the first and/or second access network node to change its respective identifier to be identical with the respective identifier of the other access network node when the timing advance values are determined to be the same.

The network node may be a first access network node and the another network node may be a centralized unit.

The method may comprise: signalling a first mapping to a user equipment, the first mapping associating a first cell provided by a first access network node to a first timing advance group identifier, the first timing advance group identifier being associated with a first set of cells having a same first timing advance value, the first set of cells comprising the first cell; and signalling a second mapping to the user equipment, the second mapping associating a second cell provided by the second access network node to a second timing advance group identifier, the second timing advance group identifier being associated with a second set of cells having a same second timing advance value, the second set of cells comprising the second cell.

The second set of cells may comprise a candidate cell.

According to a ninth aspect, there is provided a method for an apparatus for a user equipment, the method comprising: signalling a measurement report to a first network access node via a first cell, the measurement report comprising an indication of a signal quality associated with a second cell provided by a second access network node; receiving an instruction to connect to the second cell, the second cell being provided by a second network access node, wherein the instruction indicates whether the user equipment is to connect to the second cell with or without obtaining a new timing advance value; and connecting to the second cell in accordance with the received instruction.

The method may comprise, signalling the indication of the signal quality associated with the second cell with a second timing advance group identifier, the second timing advance group identifier being associated with a second set of cells having a same second timing advance value, the second set of cells comprising the second cell.

The method may comprise signalling an indication of whether that the second timing advance group identifier is valid with the measurement report.

The method may comprise: receiving a first mapping, the first mapping associating the first cell to a first timing advance group identifier, the first timing advance group identifier being associated with a first set of cells having a same first timing advance value, the first set of cells comprising the first cell; and receiving a second mapping, the second mapping associating the second cell to a second timing advance group identifier, the second timing advance group identifier being associated with a second set of cells having a same second timing advance value, the second set of cells comprising the second cell.

The connecting to the second cell may comprise switching from the first cell to the second cell.

The first cell may be a serving cell and the second cell may be a candidate cell.

According to a tenth aspect, there is provided an apparatus for a first access network node, the apparatus comprising: receiving circuitry for receiving, from the user equipment via a first cell provided by the first access network node, a measurement report comprising an indication of a signal quality associated with a second cell provided by a second access network node; determining circuitry for determining, based on the measurement report, to instruct the user equipment to connect to the second cell; determining circuitry for determining whether a second timing advance value associated with the second access network node is valid; determining circuitry for determining whether to instruct the user equipment to connect to the second cell without obtaining a new timing advance value for the second access network node when the second timing advance value is determined to be valid, or to instruct the user equipment to connect to the second cell with obtaining a new timing advance value when the second timing advance value is determined to be invalid; and instructing circuitry for instructing the user equipment in accordance with the determining whether to instruct.

The determining circuitry for determining whether the second timing advance value is valid may comprise: receiving circuitry for receiving, from the user equipment, a second timing advance group identifier with the indication of the signal quality associated with the second cell, the second timing advance group identifier being associated with a second set of cells having a same second timing advance value, the second set of cells comprising the second cell; and determining circuitry for determining whether the second timing advance value is valid using the second timing advance group identifier.

The determining circuitry for determining that the second timing advance value is valid may comprise: receiving circuitry for receiving, from the user equipment, an indication of whether the second timing advance group identifier is valid; and determining circuitry for determining whether the second timing advance value is valid using the received indication of whether the second timing advance group identifier is valid.

The determining circuitry for determining whether the second timing advance value is valid may comprise: receiving circuitry for receiving, from another network node, a second timing advance group identifier and an indication of a duration of time for which the second timing advance value is valid, the second timing advance group identifier being associated with a second set of cells having a same second timing advance value, the second set of cells comprising the second cell; and using circuitry for using the duration of the time to determine whether the second timing value is valid.

The apparatus may comprise: initializing circuitry for initializing a timer using the indicated duration on receipt of the indication of the duration; and starting circuitry for starting the timer.

The another network node may be the second access network node or the another network node may be a centralized unit.

The apparatus may comprise signalling circuitry for signalling an indication of the second timing advance value to the user equipment.

The first access network node may be associated with a first timing advance group identifier being associated with a first set of cells having a same first timing advance value, wherein the first set of cells comprises the first cell.

The connecting circuitry for connecting to the second cell may comprise switching circuitry for switching from the first cell to the second cell.

The first cell may be a serving cell and the second cell may be a candidate cell.

The apparatus may comprise: providing circuitry for providing a plurality of first cells; associating circuitry for associating each of the plurality of first cells with a timing advance value for the user equipment; grouping circuitry for grouping the plurality of first cells into different groups such that each group is associated with a same timing advance value; and assigning circuitry for assigning each of the different groups a respective identifier.

The apparatus may comprise: signalling circuitry for signalling, to a centralized unit, a mapping that indicates a correspondence between a respective identifier and its associated timing advance value.

The apparatus may comprise: receiving circuitry for receiving, from the centralized unit, an instruction to change a respective identifier associated with a specified timing advance value; and changing circuitry for changing the identifier associated with the specified timing advance value.

According to an eleventh aspect, there is provided an apparatus for a network node, the apparatus comprising: determining circuitry for determining a second timing advance group identifier that is associated with a second set of cells having a same second timing advance value, at least one cell of the second set of cells being provided by a second access network node; determining circuitry for determining a duration of validity of the second timing advance value; and signalling circuitry for signalling the duration of validity to another network node.

The network node may be a centralized unit and the another network node may be a first access network node. The apparatus may comprise: configuring circuitry for configuring the second timing advance group identifier at a second access network node, and configuring circuitry for configuring a first timing advance group identifier at the first access network node, the first timing advance group identifier being associated with a first set of cells having a same first timing advance value, at least one cell of the first set of cells being provided by the first access network node.

The apparatus may comprise: receiving circuitry for receiving, from the second access network node, a mapping that indicates a correspondence between a respective identifier of a group of second cells provided by the second access network node and its associated timing advance value; receiving circuitry for receiving, from a first access network node, a mapping that indicates a correspondence between a respective identifier of a group of first cells provided by the first access network node and its associated timing advance value; determining circuitry for determining whether the timing advance values received are the same; and instructing circuitry for instructing the first and/or second access network node to change its respective identifier to be identical with the respective identifier of the other access network node when the timing advance values are determined to be the same.

The network node may be a first access network node and the another network node may be a centralized unit.

The apparatus may comprise: signalling circuitry for signalling a first mapping to a user equipment, the first mapping associating a first cell provided by a first access network node to a first timing advance group identifier, the first timing advance group identifier being associated with a first set of cells having a same first timing advance value, the first set of cells comprising the first cell; and signalling circuitry for signalling a second mapping to the user equipment, the second mapping associating a second cell provided by the second access network node to a second timing advance group identifier, the second timing advance group identifier being associated with a second set of cells having a same second timing advance value, the second set of cells comprising the second cell.

The second set of cells may comprise a candidate cell.

According to a twelfth aspect, there is provided an apparatus for a user equipment, the apparatus comprising: signalling circuitry for signalling a measurement report to a first network access node via a first cell, the measurement report comprising an indication of a signal quality associated with a second cell provided by a second access network node; receiving circuitry for receiving an instruction to connect to the second cell, the second cell being provided by a second network access node, wherein the instruction indicates whether the user equipment is to connect to the second cell with or without obtaining a new timing advance value; and connecting circuitry for connecting to the second cell in accordance with the received instruction.

The apparatus may comprise, signalling circuitry for signalling the indication of the signal quality associated with the second cell with a second timing advance group identifier, the second timing advance group identifier being associated with a second set of cells having a same second timing advance value, the second set of cells comprising the second cell.

The apparatus may comprise signalling circuitry for signalling an indication of whether that the second timing advance group identifier is valid with the measurement report.

The apparatus may comprise: receiving circuitry for receiving a first mapping, the first mapping associating the first cell to a first timing advance group identifier, the first timing advance group identifier being associated with a first set of cells having a same first timing advance value, the first set of cells comprising the first cell; and receiving circuitry for receiving a second mapping, the second mapping associating the second cell to a second timing advance group identifier, the second timing advance group identifier being associated with a second set of cells having a same second timing advance value, the second set of cells comprising the second cell.

The connecting to the second cell may comprise switching from the first cell to the second cell.

The first cell may be a serving cell and the second cell may be a candidate cell.

According to a thirteenth aspect, there is provided non-transitory computer readable medium comprising program instructions for causing an apparatus for a first access network node to perform: receiving: receiving, from the user equipment via a first cell provided by the first access network node, a measurement report comprising an indication of a signal quality associated with a second cell provided by a second access network node; determining, based on the measurement report, to instruct the user equipment to connect to the second cell; determining whether a second timing advance value associated with the second access network node is valid; determining whether to instruct the user equipment to connect to the second cell without obtaining a new timing advance value for the second access network node when the second timing advance value is determined to be valid, or to instruct the user equipment to connect to the second cell with obtaining a new timing advance value when the second timing advance value is determined to be invalid; and instructing the user equipment in accordance with the determining whether to instruct.

The determining whether the second timing advance value is valid may comprise: receiving, from the user equipment, a second timing advance group identifier with the indication of the signal quality associated with the second cell, the second timing advance group identifier being associated with a second set of cells having a same second timing advance value, the second set of cells comprising the second cell; and determining whether the second timing advance value is valid using the second timing advance group identifier.

The determining that the second timing advance value is valid may comprise: receiving, from the user equipment, an indication of whether the second timing advance group identifier is valid; and determining whether the second timing advance value is valid using the received indication of whether the second timing advance group identifier is valid.

The determining whether the second timing advance value is valid may comprise: receiving, from another network node, a second timing advance group identifier and an indication of a duration of time for which the second timing advance value is valid, the second timing advance group identifier being associated with a second set of cells having a same second timing advance value, the second set of cells comprising the second cell; and using the duration of the time to determine whether the second timing value is valid.

The apparatus may be caused to perform: initializing a timer using the indicated duration on receipt of the indication of the duration; and starting the timer.

The another network node may be the second access network node or the another network node may be a centralized unit.

The apparatus may be caused to perform signalling an indication of the second timing advance value to the user equipment.

The first access network node may be associated with a first timing advance group identifier being associated with a first set of cells having a same first timing advance value, wherein the first set of cells comprises the first cell.

The connecting to the second cell may comprise switching from the first cell to the second cell.

The first cell may be a serving cell and the second cell may be a candidate cell.

The apparatus may be caused to perform: providing a plurality of first cells; associating each of the plurality of first cells with a timing advance value for the user equipment; grouping the plurality of first cells into different groups such that each group is associated with a same timing advance value; and assigning each of the different groups a respective identifier.

The apparatus may be caused to perform: signalling, to a centralized unit, a mapping that indicates a correspondence between a respective identifier and its associated timing advance value.

The apparatus may be caused to perform: receiving, from the centralized unit, an instruction to change a respective identifier associated with a specified timing advance value; and changing the identifier associated with the specified timing advance value.

According to a fourteenth aspect, there is provided non-transitory computer readable medium comprising program instructions for causing an apparatus for a network node to perform: determining a second timing advance group identifier that is associated with a second set of cells having a same second timing advance value, at least one cell of the second set of cells being provided by a second access network node; determining a duration of validity of the second timing advance value; and signalling the duration of validity to another network node.

The network node may be a centralized unit and the another network node may be a first access network node. The apparatus may be caused to perform: configuring the second timing advance group identifier at a second access network node, and configuring a first timing advance group identifier at the first access network node, the first timing advance group identifier being associated with a first set of cells having a same first timing advance value, at least one cell of the first set of cells being provided by the first access network node.

The apparatus may be caused to perform: receiving, from the second access network node, a mapping that indicates a correspondence between a respective identifier of a group of second cells provided by the second access network node and its associated timing advance value; receiving, from a first access network node, a mapping that indicates a correspondence between a respective identifier of a group of first cells provided by the first access network node and its associated timing advance value; determining whether the timing advance values received are the same; and instructing the first and/or second access network node to change its respective identifier to be identical with the respective identifier of the other access network node when the timing advance values are determined to be the same.

The network node may be a first access network node and the another network node may be a centralized unit.

The apparatus may be caused to perform: signalling a first mapping to a user equipment, the first mapping associating a first cell provided by a first access network node to a first timing advance group identifier, the first timing advance group identifier being associated with a first set of cells having a same first timing advance value, the first set of cells comprising the first cell; and signalling a second mapping to the user equipment, the second mapping associating a second cell provided by the second access network node to a second timing advance group identifier, the second timing advance group identifier being associated with a second set of cells having a same second timing advance value, the second set of cells comprising the second cell.

The second set of cells may comprise a candidate cell.

According to a fifteenth aspect, there is provided non-transitory computer readable medium comprising program instructions for causing an apparatus for a user equipment to perform: signalling a measurement report to a first network access node via a first cell, the measurement report comprising an indication of a signal quality associated with a second cell provided by a second access network node; receiving an instruction to connect to the second cell, the second cell being provided by a second network access node, wherein the instruction indicates whether the user equipment is to connect to the second cell with or without obtaining a new timing advance value; and connecting to the second cell in accordance with the received instruction.

The apparatus may be caused to perform, signalling the indication of the signal quality associated with the second cell with a second timing advance group identifier, the second timing advance group identifier being associated with a second set of cells having a same second timing advance value, the second set of cells comprising the second cell.

The apparatus may be caused to perform signalling an indication of whether that the second timing advance group identifier is valid with the measurement report.

The apparatus may be caused to perform: receiving a first mapping, the first mapping associating the first cell to a first timing advance group identifier, the first timing advance group identifier being associated with a first set of cells having a same first timing advance value, the first set of cells comprising the first cell; and receiving a second mapping, the second mapping associating the second cell to a second timing advance group identifier, the second timing advance group identifier being associated with a second set of cells having a same second timing advance value, the second set of cells comprising the second cell.

The connecting to the second cell may comprise switching from the first cell to the second cell.

The first cell may be a serving cell and the second cell may be a candidate cell.

According to a sixteenth aspect, there is provided a computer program product stored on a medium that may cause an apparatus to perform any method as described herein.

According to a seventeenth aspect, there is provided an electronic device that may comprise apparatus as described herein.

According to an eighteenth aspect, there is provided a chipset that may comprise an apparatus as described herein.

### BRIEF DESCRIPTION OF FIGURES

Some examples, will now be described, merely by way of illustration only, with reference to the accompanying drawings in which:

FIG. 1 shows a schematic representation of a 5G system;

FIG. 2 shows a schematic representation of a network apparatus;

FIG. 3 shows a schematic representation of a user equipment;

FIG. 4 illustrates signalling between apparatus;

FIGS. 5 and 6 illustrate an information element;

FIG. 7 illustrates signalling between apparatus;

FIGS. 8 to 9 illustrate example signalling between apparatus; and

FIGS. 10 to 12 illustrate example operations that may be performed by apparatus described herein.

### DETAILED DESCRIPTION

The following describes operations that may be performed more efficiently performing mobility events, such as cell changes, in a radio access network.

In particular, the following relates to enabling a user equipment (UE) to more quickly perform a mobility event by determining a validity of a timing advance value associated with a candidate cell. When the timing advance value is determined to be valid when the mobility event occurs, the UE may access the associated candidate cell without using a random access channel (RACH) procedure. In other words, the UE may access the associated candidate cell using a RACH-less procedure. In practice, thus may be shown by a UE that does not perform random access to the candidate cell during a time period between the UE being triggered to access the candidate cell and the UE establishing a radio resource control (RRC) connection to the candidate cell.

To help facilitate the determination of the validity of the timing advance value, candidate cells may be associated with a new timing advance identifier. Potential examples of this new timing advance identifier are described further below.

For completeness, a brief description of timing advance is now provided.

Timing advance is a command from a network access node to a UE that informs the UE how the UE can adjust the UE's uplink transmission (e.g., on the physical uplink shared channel (PUSCH), the physical uplink control channel (PUCCH), and/or sounding reference signal (SRS)) to align with downlink transmissions made from the network access node to the UE.

The timing advance command may be provided via a media access control (MAC) layer command. There are at least two different occasions when MAC commands may carry the timing advance command.

For example, the timing advance command may be provided during a random access channel (RACH) procedure when the UE is attempting to access an access network node (e.g., in response to the UE signalling a RACH preamble to the access network node). The timing advance command provided during the RACH may set an initial value for how the UE is to adjust the timing of its uplink transmissions.

As another example, the timing advance command may be provided in a specific MAC control element, labelled as a Timing Advance Command MAC control element. This specific MAC control element may provide updates to the initial value (and subsequent values for adjusting the UEs uplink transmission timing).

In current specifications, the timing advance command may comprise a single octet that comprises a timing advance group (TAG) identifier (TAG-ID) and at least one value for the timing advance (e.g., an index value used for controlling the amount of timing adjustment that the UE is to apply).

The TAG-ID identifies a TAG. The TAG-ID uniquely identifies the TAG within the scope of a cell group (e.g., secondary cell group). Each TAG comprises at least one serving cell with configured uplink, and the mapping of each serving cell to a TAG is configured by Radio Resource Control (RRC) level signalling. The TAG-ID indicates at least one cell to which the timing advance command is to be applied. In current specifications, the TAG-ID is a 2 bit field. The TAG comprising a secondary primary cell comprises a TAG-ID of 0.

The MAC entity has a configurable timer (also labelled as a “timeAlignmentTimer”) per TAG. The configurable timer is used to control how long the MAC entity in the UE considers the cells belonging to the associated TAG to be uplink time aligned. The timer associated with a TAG is started (or restarted) each time a timing advance command is received that identifies that TAG.

In the following description of examples, certain aspects are explained with reference to devices that are often capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals, IEEE 802.11, etc.).

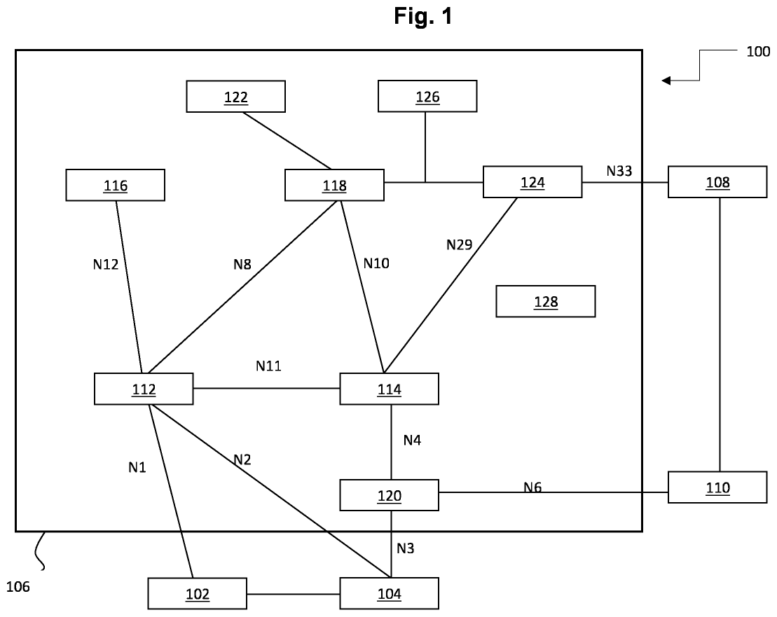

Before describing in detail the examples, certain general principles of a 5G wireless communication system are briefly explained with reference to FIGS. 1 to 3.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

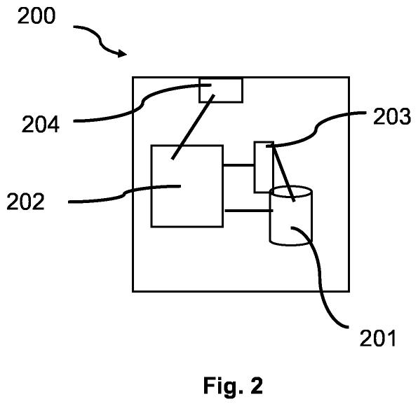

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” herein are understood to refer to software code, and vice versa.

The station of the access system may be categorised into two different types: distributed units (DUs), and centralised units (CUs).

A DU provides access node support for lower layers of the protocol stack (such as, for example, the radio link control (RLC), medium access control (MAC), and/or physical layer protocol layers). Each DU is able to support one or more cells, while each cell is able to support one or more beams.

A CU can support multiple DUs, and provides access node support for higher layers of the protocol stack within an access node (such as, for example, packet data convergence protocol (PDCP), service data adaptation protocol (SDAP), and/or radio resource control (RRC) protocol layers). The interface between a CU and a DU is labelled as an F1 interface. There is a single CU for each gNB, and CU's belonging to multiple gNB may be implemented using a shared hardware platform.

The following description also provides illustrative examples with reference to duel connectivity (DC) systems. DC systems may comprise a master node and at least one secondary node. It is understood that the presently described principles are not limited to such terminology, and may be applied to other systems having a similar architecture.

PSCells are a type of cell currently defined in 5G New Radio, along with Primary Cells (PCells), Secondary Cells (SCells) and Special Cells (SpCells). A PCell may be used as part of an initial access between a UE and an access network, and is considered to be a main cell in a master cell group (MCG). A PSCell may be comprised as part of a secondary cell group (SCG). The SpCells and SCells may be in at least one of the MCG and the SCG.

The cells may be controlled by network nodes. There are a maximum of two different types of network nodes in 5G New Radio: Master nodes (which provide a control plane connection to a core network); and Secondary Nodes (which do not have control plane connections to the core network). It is understood that not all 5G system deployments may comprise a master node and a secondary node. For example, the Master and Secondary nodes may be present in a master node-dual connectivity deployment, but not in a standalone deployment. The Master and Secondary nodes may both provide user plane (e.g. data) connections to the core network. The Master node may control the PCell. In addition to the PCell, the Master node may control at least one PSCell, although this is not always the case. The Secondary node may control at least one PSCell.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0(2021 -06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:

### Option 1 (1A-like Split):

The function split in this option is similar to the 1A architecture in DC. RRC is in the central unit. PDCP, RLC, MAC, physical layer and RF are in the distributed unit.

### Option 2 (3C-like Split):

The function split in this option is similar to the 3C architecture in DC. RRC and PDCP are in the central unit. RLC, MAC, physical layer and RF are in the distributed unit.

### Option 3 (Intra RLC Split):

Low RLC (partial function of RLC), MAC, physical layer and RF are in the distributed unit. PDCP and high RLC (the other partial function of RLC) are in the central unit.

### Option 4 (RLC-MAC Split):

MAC, physical layer and RF are in the distributed unit. PDCP and RLC are in the central unit.

Or else, e.g., according to 3GPP TR 38.801 V14.0.0(2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node or access node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

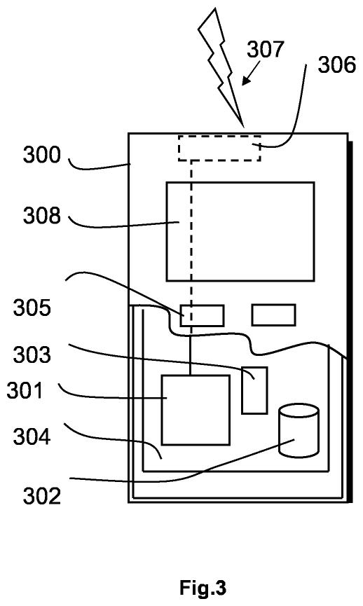

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or' wireless) to other devices and/or for connecting external accessories, for example hands-free equipment, thereto.

The wireless apparatus of FIG. 3 may comprise a user equipment. The user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

3GPP has issued a number of releases (Rel) for defining operating communication protocols related to a communications network. Currently, objectives and work are being set in relation to Release 18 (Rel. 18).

Lower Layer triggered Mobility (LTM) is one of the objectives for mobility enhancement in Rel. 18. LTM relates to a situation in which the decision about the cell change is based on Layer 1 (L1) measurements (e.g., measurements made on the physical layer) and is made in the MAC layer in the Distributed Unit (DU) (i.e., made at Layer 2). For this reason, LTM is also called L1/L2 inter-cell mobility.

LTM may be applied in respect of a variety of different mobility operations. For clarity and brevity, the following will consider cell switch operations (e.g., a UE performing a mobility operation that causes the UE to switch its serving cell from a first cell to a second cell in response to a signal degradation), and will consider cell switch operations between cells provided by different DUs. It is understood, however, that this is merely to illustrate various features, and that other types of mobility operations and/or entities may apply the presently described principles. A cell switch between a first cell provided by a first DU and a second cell provided by a second DU is referred to as an inter-DU cell switch.

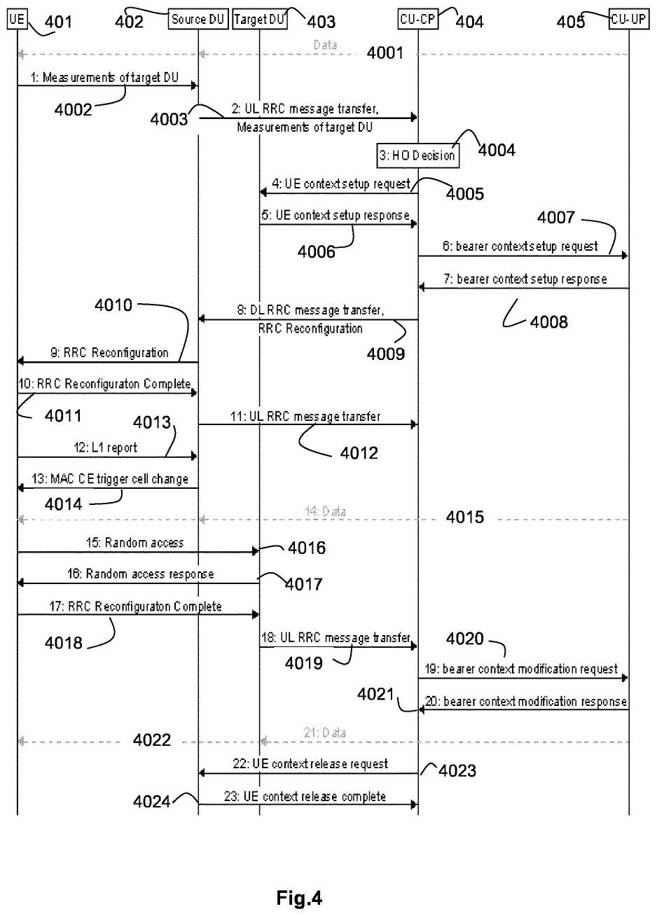

FIG. 4 illustrates example signalling that may be performed between different entities in relation to an inter-DU cell switch LTM scenario.

FIG. 4 illustrates signalling that may be performed between a UE 401, a source DU 402, a target DU 403, a control plane part of a centralised unit (CU) (CU-CP) 404, and a user plane part of a centralised unit (CU-UP) 405. The source DU may be providing a first cell that acts as a serving cell to the UE 401. The target DU 403 may provide a second cell that is a candidate cell for the UE for to switch to from the first cell.

During 4001, the UE 401 is communicating traffic over the network via the source DU 402 and the CU-UP 405.

During 4002, the UE 401 signals the source DU 402. This signalling of 4002 comprises layer 3 (e.g., network layer) measurements made on signals transmitted by the target DU 403.

During 4003, the source DU 402 signals the CU-CP 404. This signalling may comprise the measurements received during 4002. This signalling may be comprised in an uplink radio resource control (RRC) message.

During 4004, the CU-CP 404 makes a handover decision. This handover decision may comprise a decision to prepare at least one cell provided by the target DU 403 for a handover of the UE 401 from the source DU 402 to the target DU 403.

During 4005, the CU-CP 404 signals the target DU 403 to prepare the at least one cell. This signalling may comprise UE context for the UE 401. This signalling may comprise a UE context setup request service operation.

After receiving the signalling of 4005, the target DU 403 prepares the at least one cell using the received UE context. Further, during 4006, the target DU 403 responds to the signalling of 4005 to confirm that the UE context has been received. This signalling may comprise a UE context setup response service operation.

During 4007, the CU-CP 404 signals the CU-UP 405. This signalling may comprise a request for the CU-UP 405 to setup a bearer context in relation to the at least one cell. The signalling of 4007 may comprise a bearer context setup request message.

During 4008, the CU-UP 405 signals the CU-CP 404. This signalling may indicate that resources have been allocated for the bearer context setup in response to the signalling of 4007. For example, this signalling may comprise uplink user plane parameters for use by the target DU 403 in communicating user plane traffic from the UE 401. This signalling may comprise a bearer context setup response message.

During 4009, the CU-CP 404 signals the source DU 402. This signalling may comprise a radio resource control (RRC) reconfiguration to be applied by the UE 401. This signalling may be comprised in a downlink RRC message transfer service operation.

During 4010, the source DU 402 provides the RRC reconfiguration received during 4009 to the UE 401.

During 4011, after the UE 401 has received the received RRC reconfiguration received during 4010, the UE 401 signals the source DU 402. This signalling may indicate that the UE has received the received RRC reconfiguration. This signalling may comprise an RRC reconfiguration complete message.

During 4012, the source DU 402 forwards the received RRC reconfiguration complete message to the CU-CP 404. This signalling may be comprised in an uplink RRC message transfer service operation.

During 4013, the UE 401 signals a L1 measurement report to the source DU 402. This L1 measurement report may be provided periodically, according to a reporting configuration of the UE 401.

During 4014, the source DU 402 signals the UE 401. This signalling is made when the source DU has decided, based on the received L1 measurement report of 4013, that the UE is to be handed over to another DU (e.g., to target DU 403) from the source DU 402. This signalling may comprise a MAC control element that is configured to trigger the UE 401 to perform a cell change operation.

Up until 4014, the UE 401 is still receiving data/traffic via the first cell provided by the source DU 402. This is illustrated in 4015.

During 4016, the UE 401 applies the received RRC reconfiguration for a target cell provided by target DU 403 and performs random access to it by signalling a random access preamble to the target DU 403.

During 4017, the UE 401 receives a response to the random access procedure of 4016. Although the random access procedure is illustrated as two steps in 4016 and 4017, it is understood that this is not limiting, and the overall random access procedure may take more steps than shown (e.g., four steps) or may not be performed at all. For example, RACH may not be performed when a Random Access Channel (RACH)-less mechanism is employed.

Further, when a RACH-based based Timing Advance (TA) acquisition mechanism is used, the UE 401 may also perform early TA acquisition for the target cell during the RACH procedure. For example, the UE may receive a timing advance command in the RACH signalling.

To enable early TA acquisition in Rel-18 LTM, the source DU may send a Physical Downlink Control Channel (PDCCH) order to the UE to instruct the UE to acquire TA for the target/candidate cell before the MAC CE (cell switch command) is sent to the UE. In this case, the UE 401 may not need to perform any additional RACH signalling after the reception of the MAC control element (e.g., the cell switch command) from the source DU received during 4014.

During 4018, the UE 401 signals the target DU 403. This signalling may indicate that the RRC reconfiguration of 4010 has been completed. This signalling may comprise an RRC reconfiguration complete message.

During 4019, the target DU 403 signals the CU-CP 404. This signalling may forward the RRC reconfiguration complete message of 4018 to the CU-CP 404. This signalling may be comprised in an uplink RRC message transfer service operation.

During 4020, the CU-CP 404 signals the CU-UP 405. This signalling may comprise a request to modify the bearer context for the UE to update the bearer setup to route traffic for the UE 401 through the target DU 403 instead of through the source DU 402.

During 4021, the CU-UP 405 signals the CU-CP 404. This signalling may confirm that the bearer context modification request of 4020 has been performed.

During 4022, the CU-UP 405 communicates traffic to and/or from the UE 401 via the target DU 403.

During 4023, the CU-CP 404 signals the source DU 402. This signalling may request UE context release (e.g., release of UE context associated with the UE 401) at the source DU 402. This signalling may comprise a UE context release request message.

During 4024, the source DU 402 signals the CU-CP 404 to indicate that the source DU 402 has released the UE context, as requested. This signalling may comprise a UE context release complete message.

3GPP previously determined that it is not practical to maintain an independent and/or separate TA for each serving cell. Instead, serving cells are grouped into a set in dependence on their relative collocation to each other, and a same TA is maintained across all the serving cells belonging to that grouped set.

Timing Advance Group (TAG) was introduced in Release 11. A TAG comprises a plurality of serving cells that are each associated with the same uplink TA and same downlink timing. Each TAG contains at least one serving cell with configured uplink, and the mapping of each serving cell to a TAG is configured by RRC.

The TAG containing a PCell is called a pTAG (Primary Timing Advance Group), and uses the PCell timing for a timing reference.

When a TAG comprises only SCells(s), then it is called an sTAG (Secondary Timing Advance Group), and any of the activated SCells of this TAG may be statically selected for use as a timing reference cell (i.e., selected for use as a timing reference cell for at least a predetermined duration of time).

The TAG configuration may be comprised in a MAC cell group configuration information element (MAC-cellGroupConfig). The MAC cell group configuration information element may comprise other configuration information, such as, for example, a discontinuous reception configuration.

Currently, the MAC cell group configuration has a TAG-configuration for the serving cells provided by the distributed unit. The TAG-configuration comprises a TAG-ID and a configurable TAG timer (timealignmenttimer). This TAG specific timealignmenttimer may be provided by RRC at the time of TAG configuration. As this parameter is included in each MAC-CellGroupConfig, timealignmenttimer is serving cell specific.

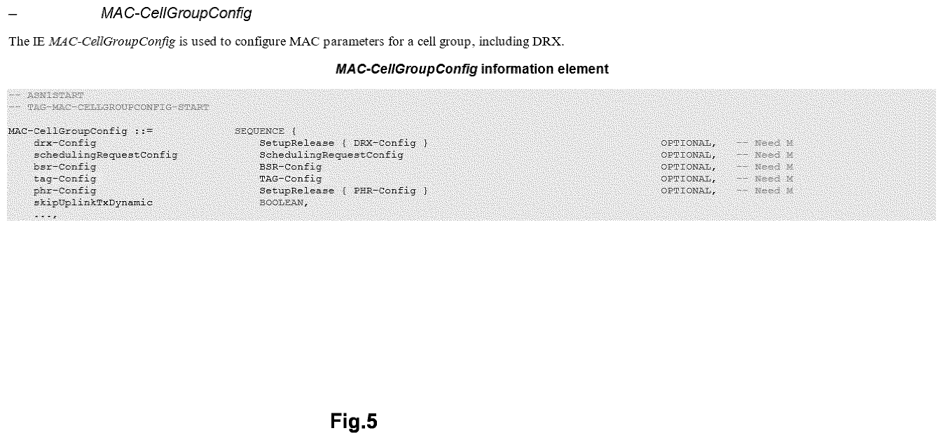

FIGS. 5 and 6 respectively illustrate examples of a MAC cell group configuration information element and a TAG-configuration element.

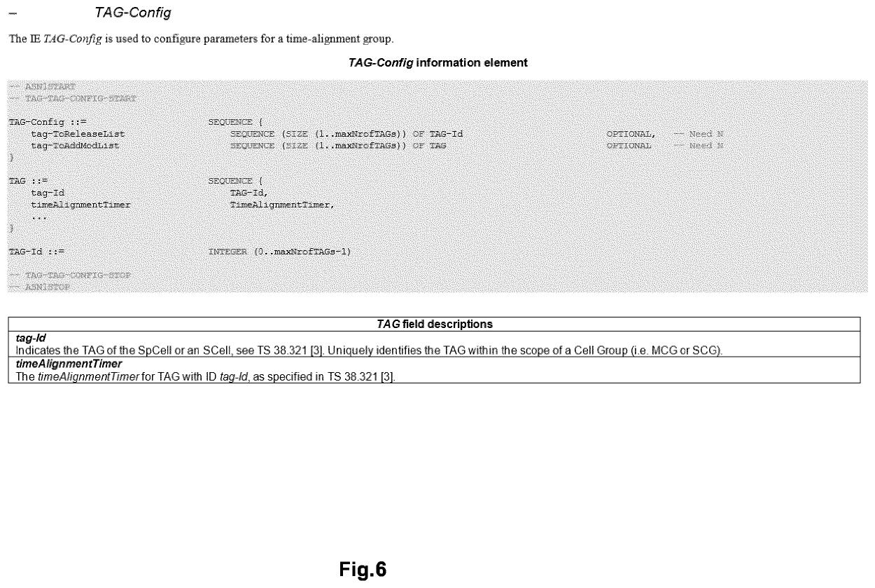

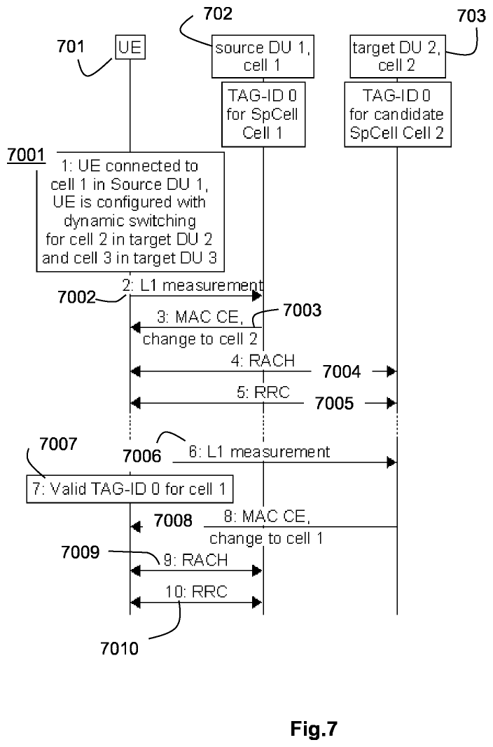

The configuration of a TAG may be performed as illustrated below in relation to FIG. 7.

FIG. 7 illustrates operations that may be performed by various entities. FIG. 7 illustrates a UE 701, a first source cell 702 provided by a source DU, and a first target cell 703 provided by a first target DU. The first source cell is associated with a TAG-ID 0 for SpCell Cell of the first source cell. The first target cell is associated with a TAG-ID 0 for candidate SpCell of the first target cell. Although not shown, there may be further provided a second target cell provided by a second target DU. In other words, in FIG. 7, the TAG group of cells of the first source cell, the first target cell, and the second target cell provided by the various DU are associated with a same TAG-ID.

During 7001, the UE 701 is connected to the first source cell 702, and is configured with dynamic switching for the first target cell and second target cell.

During 7002, the UE 701 signals the first source cell 702. This signalling may comprise L1 measurement information, according to the configuration of the UE 701 (e.g., as described above in relation to FIG. 4).

During 7003, the UE 701 receives a signal from the first source cell 702 for triggering the UE to perform a handover from the first source cell 702 to the first target cell 703. This signalling may comprise a MAC control element.

During 7004, the UE 701 performs a random access procedure for accessing the first target cell 703.

During 7005, the UE 701 and first target cell 703 exchange radio resource control information. This RRC information may comprise an LTM configuration. The LTM configuration may comprise a MAC cell group configuration comprising at least one TAG-ID for the first target cell and/or second target cell. This TAG-ID may be fixed to TAG-ID 0 for the special candidate cells (e.g., primary cells of the master cell group and/or secondary cell group). One or both of these TAG-IDs may collide with the TAG-ID of the current source cell configuration of the UE (e.g., TAG-ID 0 is allocated for the first source cell). When a UE reports a TAG-ID that the network is unable to map to a specific cell (e.g., as the UE is configured with a same TAG-ID for different cells), this TAG-ID is said to collide.

During 7006, the UE 701 signals an L1 measurement report to the first target cell 703 using its L1 reporting configuration.

During 7007, the UE 701 determines that it has a valid TAG-ID 0 for the first source cell.

During 7008, the first target cell 703 signals the UE for causing the UE to perform a handover from the first target cell 703 to the first target cell. This signalling may comprise a MAC control element.

During 7009, the UE 701 performs a random access procedure towards the first source cell 702 for accessing the first target cell.

During 7010, the UE 701 and first source cell 702 exchange radio resource control information. This RRC information may comprise an LTM configuration.

In the example of FIG. 7, when the UE is executing a cell change from the first source cell to the first target cell, the UE may maintain the timing advance for the first source cell for a certain duration, (e.g., for the duration of TimeAlignmentTimer) after receiving the trigger to perform the handover (e.g., after 7003).

Even when UE has at least one timing alignment timer for the serving cells, the UE is unaware that some of these timing alignment timers might apply to the candidate cells. The UE is only aware that a timer alignment timer applies to only a subset of the UE's serving cells.

In the event of a ping-pong handover, the first target DU may indicate to the UE to switch back from the second cell to the first cell using a cell switch command (e.g., 7008) with RACH procedure (e.g., 7009). The first target DU may ask the UE to perform early TA acquisition for the first cell. For example, the first target DU may send a Physical Downlink Control Channel (PDCCH) instruction to the UE asking to transmit a Physical Random Access Channel (PRACH) preamble to the first source cell) before the MAC control element cell switch command is sent in 7008.

In this example of FIG. 7, the UE may report an acquired TA value to the target cell after cell switch.

In more detail, a source-DU/CU and target-DU/CU may coordinate on the TA report configuration and information comprised in. The report may comprise at least one of the following information elements:

TAG (e.g., a physical cell identifier (PCI-IDs) and potentially corresponding transmission control indicator (TCI) states)
TA values associated with each TAG (PCI/TCI state)
TAT status associated with each TAG (PCI/TCI state)
TA acquisition/update method and UE preference for TA acquisition/update. UE capability (limitations) to acquire/update TA in terms of number of TAGs (or cells), or methods to acquire the TA, and TA update limitations, etc.

The source-DU and target-DU may coordinate on a method to transfer TA information therebetween.

For example, the UE may configured to send this information to the target-DU (cell) after cell switch.

As another example, before the cell switch, the target DU (cell) may provide the source-DU with a report configuration and uplink resources for the UE to use when transmitting the TA report immediately after cell switch to the target-DU.

As another example, after cell switch, the target DU may send a TA report request (including report configuration, and uplink resources) to the UE for use by the UE in sending the TA report to the target-DU (cell) after cell switch.

In another example, the source-DU/CU may provide this TA information to the target-DU/CU prior to or during cell switching procedure.

In another example, this TA information may be transferred between source-DU and target-DU over an F1 interface (applicable for both intra and inter CU scenarios).

In another example (e.g., for intra-CU scenarios), the source-DU may send this TA information to the target-DU via CU-CP. For inter-CU (gNB) case, the TA information may be transmitted between CUs through an Xn interface.

The mechanism of FIG. 7 enables a UE to report a TAG ID with a PCell ID. This causes reporting overhead for the UE and UE may not be aware of complete set of cells that share a TAG ID. This might cause a UE to do RACH to a target cell for which it has a running timing advance value.

Further, in this example of FIG. 7, the UE is performing a RACH procedure to obtain timing advance even when the UE is already currently maintaining a timing advance value associated with the first source cell. The present application identifies that this may result in unnecessary RACH signalling, and in delayed cell switch.

One mechanism for avoiding the unnecessary RACH may be that the UE indicates the TAG-ID of the maintained timing advance for the cell. This may be signalled when reporting the L1 measurement to the first target cell (e.g., during 7007).

In such a case, the first target DU providing the first target cell may be unable to decode for which cell and/or for which LTM configuration the UE may perform a cell switch. This may be problematic in the event of a ping-pong handover, in which the first target DU providing the first target cell may subsequently be configured to indicate to the UE to switch to the first source cell (e.g., during 7009 as part of a cell switch with RACH procedure).

In the example of FIG. 7, the UE may indicate the TAG-ID to the DU(s) when providing an L1 measurement report, but the receiving DU cannot determine to which cell is the indicated TAG-ID is related. This may, again, result in unnecessary RACH signalling and in an unnecessarily delayed cell switch.

To address at least one of the above-mentioned issues, the following proposes at least one mechanism for performing cell switch in a fast manner.

In particular, the following illustrates the use of a new type of TAG-ID that is associated with a set of cells having a same timing advance value. This means that cells provided by different transmission and reception points (e.g., different DUs) may be associated with different TAG-IDs, even while being considered for cell switch mobility events.

The different TAG-IDs may be used to make cell switch mechanisms more efficient in any of a plurality of different ways. In the examples below, a TAG may comprise at least one candidate cell. Previously, a TAG could only comprise at least one serving cell. In contrast, the TAG presently disclosed may comprise at least one candidate cell in addition to at least one serving cell. Therefore, the associated TAG-ID for this group may identify at least one candidate cell.

A single DU providing a plurality of cells may associate a first portion of the plurality of cells with a first TA value (and hence with a first TAG and first TAG-ID value), and a second portion of the plurality of cells with a second TA value (and hence with a second TAF and second TAG-ID value). When the TA value(s) of the plurality of cells provided by the single DU are determined to be the same (or to be unlikely to result in uplink interference), the single DU may associate all of its cells with a same TAG and TAG-ID value. A CU may coordinate between neighbouring DUs such that the cells provided by neighbouring DUs that have the same TA value are all associated with the same TAG and TAG-ID value.

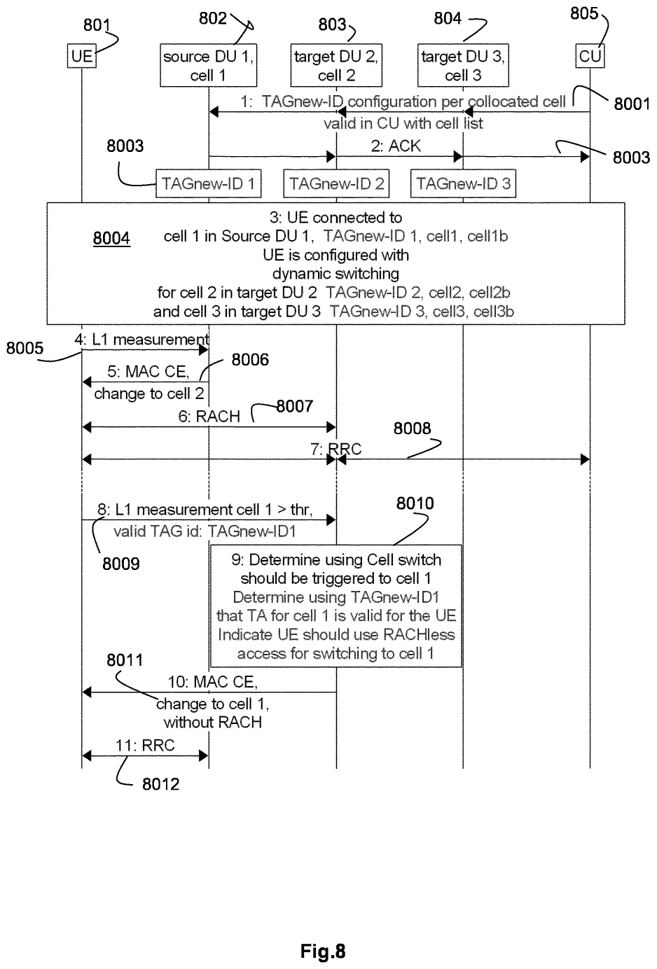

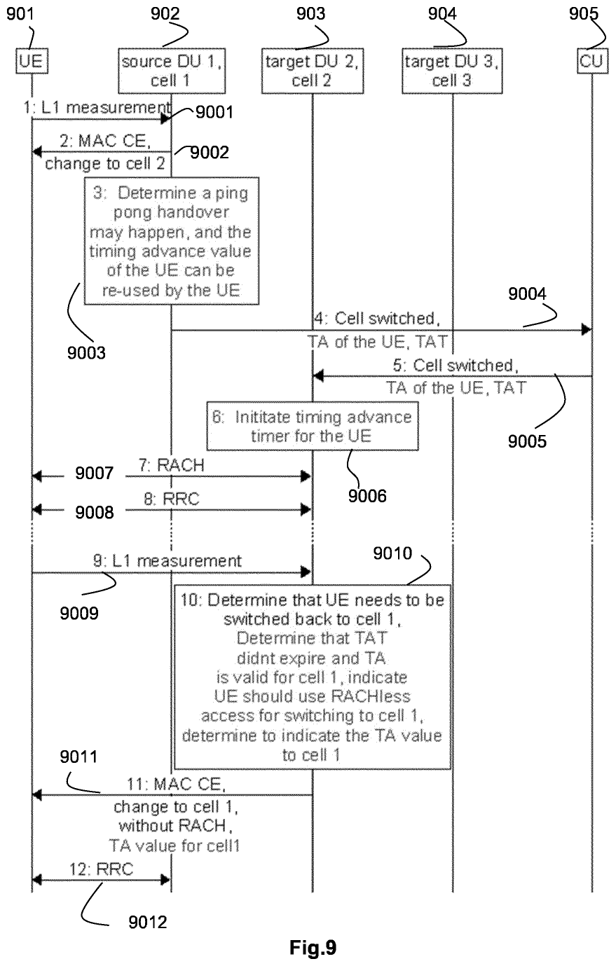

FIGS. 8 and 9 illustrate some examples of how the different TAG-IDs may be used.

FIG. 8 illustrates signalling that may be performed between a UE 801, a first source DU 802 providing a first (serving) cell and cell 1b, a first target DU 803 providing a second cell and cell 2b, a second target DU 804 providing a third cell and cell 3b, and a centralised unit 805.

During 8001, all of the cells having the same timing advance value are grouped together and associated with a unique TAG-ID (labelled herein as TAGnewID) that is unique to that group of cells. Although this may be reflected in assigning cells of different transmission and reception points that have the same timing advance value the same unique TAG-ID, in practice it may often appear to group together cells provided by a same transmission and reception point (e.g., by a same DU). To illustrate this, FIG. 8 illustrates the first source DU 802, first target DU 803, and the second target DU 804 each being configured with respective unique TAG-IDs (labelled herein as TAGnewID). A single unique TAG-ID may be associated to all cells provided by the DU configured with that unique TAG-ID.

The same unique TAG-ID (TAGnewID) may be associated to a set of cells of different DUs that have the same TA.

The unique TAG-ID may be unique per UE or unique for all UEs (e.g., there may be a common unique TAG-ID used by a plurality of UEs). If a UE is able to provide a “better” timing advance self estimation and/or correction (e.g., that UE comprises a predetermined set of hardware and/or software, and/or is able to estimate an accuracy of it's timing advance value to be within a predetermined threshold), that UE may be able to configure a larger timing advance group than UEs unable to provide a “better” timing advance self estimate and/or correction.

The unique TAG-ID may be configured with a list of cells associated to the that unique TAG-ID. This list of associated cells may be related to the serving cells, candidate cells or potential candidate cells for the UE.

Although FIG. 8 shows the DUs being configured with their respective unique TAG-IDs by signalling from the CU 805 signalling each of the DUs, it is understood that the DUs may instead be configured in some other way.

For example, the DUs may instead be configured with their TAG-IDs by an Operations and Maintenance (OAM) entity.

In another example, the DUs can determine their TAGnewID and ask for the CU to confirm the allocation or ask to update if their TAGnewID is associated with a timing advance value that is overlapping (e.g., identical or with a limited) with the timing advance value(s) associated with TAGnewIDs of neighbouring cells. For example, a DU may set a TAGnewID for its own cells and indicate this for each cell that DU controls. The DU may indicate multiple TAGnewIDs if multiple identifiers are needed to represent multiple timing advances provided by the various cells of the DU. The DU may signals its TAGnewID(s) with an associated timing advance value to a CU. When a CU sees that neighbour DUs may use the same timing advance (e.g., using the TAGnewID-TA value mapping provided by the different DUs), the CU can coordinate the two DUs to use the same TAGnewID for the group of cells for which the timing advance is the same. Two different timing advance values may be considered overlapping when a difference between the timing advance values is determined to be within the cyclic prefix limit of the system to guarantee no uplink interference will be caused if there is a difference between timing advances of a cell group.

During 8002, the DUs acknowledge that they are configured with their respective new TAGnewIDs to their configuring entity. In the present example, this is illustrated by the DUs signalling respective acknowledgements to the CU 805.

Subsequently, at 8003, the first source DU 802 is associated with TAGnew-ID1, the first target DU 803 is associated with TAGnew-ID2, and the second target DU 804 is associated with TAG-ID3.

The effect of 8001 to 8003 is to configure each of the DUs with a respective TAGnew-ID. For example, the CU 805 may configure the DUs for a global TAG-ID per Transmission Reception Point (TRP), and the DUs may acknowledge the configuration. In some examples, the DUs may each indicate the TAG-ID(s) they have to a coordinating CU (e.g., CU 805), and that coordinating CU may align the TAG-IDs among all DUs to allocate a unique ID. In another example, the OAM may configure unique TAG-IDs to the DUs to be used for LTM purposes.

During 8004, the UE 801 is connected to the first cell in the first source DU 802. The UE 801 is further configured with dynamic switching for the second cell in the first target DU 803 and with dynamic switching for the third cell in the second target DU 804. The UE associates TAGnew-ID1 with the cells provided by the first source DU 802 (e.g., with the first cell and cell 1b). The UE associates TAGnew-ID2 with the cells provided by the first target DU 803 (e.g., with the second cell and cell 2b). The UE associates TAGnew-ID3 with the cells provided by the second target DU 804 (e.g., with the third cell and cell 3b). This association may be provided with an LTM configuration In other words, the UE may be configured with LTM preparation for cell 2 with the TAGnew-ID 2 for cell 2 and with the LTM preparation for cell 3 with the TAGnew-ID 3 for cell 3.

The second cell and Cell 2b may be prepared in target DU2. In this case, UE is informed that the second cell and cell 2b belong to the same TAG through the cell list coming with the new TAG-ID (e.g., TAGnew-ID2). The use of the same TAG may indicate that these two cells belong to the same group as they are also co-located.

The third cell and Cell 3b may be prepared in target DU3. In this case, UE is informed that the third cell and cell 3b belong to the same TAG through the cell list coming with the new TAG-ID (e.g., TAGmew-ID3). The use of the same TAG may indicate that these two cells belong to the same group as they are also co-located.

TAGnew-ID2 is different from TAGnew-ID3 as the second cell and cell 2b are not co-located with the third cell and cell 3b. In an example, the UE 801 may be configured with a specific mapping rule that enables the UE to map the TAGnewIDs received during 8004 to a specific bitmap to be reported by the UE. The mapping configuration may be provided from the first source DU, and/or the CU 805, and/or first target DU 803, and/or the second target DU 804. Where the (first or second) target DU is controlled by a different CU to the first source DU, the target/different CU may provide this mapping to the UE 801.

The first source DU may signal signalling comprising the configured TAGnewID(s) (e.g., in the MACCellGroupConfig), and respective lists of cells associated to each of the configured TAG-IDs when configuring the UE with the LTM configuration. In one example, the TAGnewID(s) may be listed in the RRCReconfiguration outside of a provided configured grant configuration. In another example, the UE may permanently or statically (e.g., for a specific period) store the configured TAGnewID(s) and the related cell identifiers.

The UE may indicate in an event based, a periodical manner, or in demand the list of TAGnewIDs that it has valid to the source DU. In the present example, the term “valid” TAG-ID is used to indicate that the TA Timer associated to that TAG-ID has not yet expired. In other words, the UE may indicate to the source DU 802 that the TA Timer will run at the target cell and similarly at UE side. The indication can be signalled implicitly or explicitly.

The reporting of valid TAG-ID(s) may be provided with the L1 measurement reports. As an example, the L1 measurement reporting format may comprised indicator associated with the reported reference signal identifier that UE has/does not have valid TAG for the cell associated with the reported beam (reference signal/beam identifier). As an example, embodiment for the event based valid TAG-ID indication or the start of the periodical valid TAG-ID indication may be the provision of at least one L1 measurement report (e.g. the report may be L1-report with only RS id and quantity, Reference Signal Received Power (RSRP)) by the UE that has at least one reference signal identifier (e.g., beam ID) associated with the target cell with valid TAG-ID.

The first source DU 802 may use this information to trigger a RACHless handover procedure towards the target cell. The first source DU 802 may use the list of TAGnewIDs information to check which cells configured for candidate carrier aggregation cells, are part of valid timing advance value at the UE side to trigger carrier aggregation activation for the target cell without random access.

During 8005, the UE 801 provides an L1 measurement report to the first source DU 802 in accordance with the UE's reporting configuration. As mentioned above, this signalling may indicate whether the reference signals being reported on have a “valid” TAG-ID stored at the UE 801. The L1 measurement report may comprise TAGnew-ID2. The L1 measurement report may explicitly indicate that this TAGnew-ID2 is valid.

During 8006, the first source DU 802 signals the UE 801. This signalling may be an instruction to perform a mobility operation (e.g., to switch from the first cell to the second cell). This signalling may be provided using a MAC control element.

During 8007, the UE 801 performs a RACH procedure with the second cell of the first target DU 803. This may be performed in response to a trigger received during 8006.

During 8008, the UE 801, first target DU 803, and CU 805 act to establish a Radio Resource Control (RRC) connection between the UE 801 and the first target DU 803.

In other words, during 8005 to 8008, the UE reports L1 measurements for the second cell and no TAG-ID for cell 2. The first source DU 802 triggers a cell switch to the second cell. The UE performs RACH and applies the RRCReconfiguration of the second cell, indicating the application of this RRCReconfiguration to the first target DU.

During 8009, the UE 801 signals an L1 measurement report to the first target DU 803 in accordance with the UE's L1 reporting configuration. This signalling may indicate that an L1 measurement made in respect of a signal transmitted by the first cell has a value that exceeds a threshold amount. This signalling may comprise an indication of an identifier of the first cell. For example, this signalling may comprise TAGnew-ID1. This signalling may comprise an indication that the identifier of the first cell is a valid identifier.

The receiving DU (e.g., the first target DU 803) may be able to identify TAGnew-ID1 received from the UE 801. For example, the first target DU 803 may have received signalling indicating the TAGnewID used by the first source DU 802 and/or the second target DU 804 during 8001 to 8003. As another example, the TAGnewID may be received separately after or before the LTM configuration is provided to the UE.

In one example, the UE 801 may indicate the TAG validity with a single flag appended to the L1 measurements. The first target DU 803 may be aware of the relation of the L1 measurement to a specific cell ID. This means that the first target DU 803 may be able to determine that the signalled timing advance is valid for that cell ID. The first target DU 803 may map a cell ID received in 8009 to a TAGnewID to understand for which other cells the TAGnewID is valid.

During 8010, the first target DU 803 determines that the UE 801 should perform a cell switch from the second cell to the first cell, based on the values indicated in the signalling of 8009. The first target DU 803 may determine, using TAFnew-ID 1, that the TA for the first cell is currently valid at the UE 801, and determine to indicate this to the UE. Although this present example is presented in the context of the UE returning to the first cell, it is understood that the same techniques may be applied to any cell (even candidate cells) that are associated with the same TAGnewID that is considered valid, such as cell 1b.

This means that using the initial configuration at 8001 and the received signalling of 8009, during 8010, the first target DU may determines that it can trigger a RACHless cell switch towards cell 1.

During 8011, the first target DU 803 signals the UE 801. This signalling may indicate to the UE 801 that the UE should perform a RACHless cell switch from the second cell to the first cell. This signalling may indicate to the UE 801 that the UE 801 is to use the timing advance as configured with TAGnew-ID1. RACHless cell switch may enable the UE to more quickly access the first cell than when a RACH procedure is used.

During 8012, the UE 801 and the first source establish an RRC connection by the UE applying an RRC reconfiguration and sending an uplink message directly to the first source cell 802.

Although the above example of FIG. 8 illustrates that cell switches are made in response to an L1 measurement report being transmitted by the UE 801, before the UE report, the network (e.g., the first source DU and/or the first target DU) may poll the UE to report a list of valid TAGnewIDs held by the UE. The network may use this information to determine for which cells the network may trigger UE to acquire timing advance, and for which cells timing advance acquisition are not to be triggered.

FIG. 9 illustrates example actions that may be performed in an example.

FIG. 9 illustrates a UE 901, a first source DU 902 providing a first cell, a first target DU 903 providing a second cell, a third target DU 904 providing a third cell, and a CU 905.

During 9001, the UE 901 signals the first source DU 902. This signalling may comprise an L1 measurement report. The L1 measurement report may be performed in accordance with a configuration at the UE 901 with regards to what is measured and when the measurement(s) are reported. The L1 measurement may comprise values reflecting measurements made by the UE 901 on a reference signal transmitted in the second cell.

During 9002, the first source DU 902 signals the UE 901. This signalling may comprise an indication for enabling the UE to perform a mobility event (e.g., a cell switch from the first cell to the second cell). This signalling may comprise an MAC control element.

During 9003, the first source DU 902 may determine that the mobility is likely to be temporary (e.g., reversed such that a switch cell from the second cell to the first cell is likely to happen within a predetermined duration of time (which may be started at a predetermined point in time, e.g., starting from 9002)). During 9003, the first source DU 902 may additionally determine that the timing advance value currently being used by the UE may be re-used by the UE. The UE may therefore adjust the uplink transmission timing using a previously stored timing advance value.

During 9004, the first source DU 902 signals the CU 905. This signalling may comprise an indication that the UE is to be switched from the first cell to the second cell. This signalling may comprise an indication of the timing advance of the UE. This signalling may comprise an indication of the TAT.

During 9005, the CU 905 signals the first target DU 903. This signalling may comprise an indication that the UE is to be switched from the first cell to the second cell. This signalling may comprise an indication of the timing advance of the UE. This signalling may comprise an indication of the TAT received by the UE during 9004.

During 9006, the first target DU 903 initiates a timing advance timer for the UE 901 using the TAT value received during 9005.

During 9007, the UE 901 and the first target DU 903 perform a RACH procedure for enabling the UE to access the first target DU.

During 9008, the UE 901 and the first target DU 903 establish an RRC connection.

During 9009, the UE 901 signals an L1 measurement report to the first target DU 903. This measurement report may comprise at least one value representing a measurement made on a reference signal transmitted by the first cell. The measurement report may be transmitted and/or formed in accordance with a configuration of the UE 901.

During 9010, the first target DU 903 determines from the at least one value that the UE 901 is to be switched from the second cell to the first cell. The first target DU 903 further determines that the TAT started during 9006 has not expired (e.g., the TAT has a non-zero value). Based on these determinations, the first target DU 903 further determines that the UE 901 should access the first cell using RACHless access.

During 9011, the first target DU 903 signals the UE 901. This signalling may comprise a trigger for causing the UE to switch from the second cell to the first cell. This signalling may comprise a TA value for the first cell. This signalling may be comprised in a MAC control element.

During 9012, the UE 901 establishes an RRC connection with the first source DU 902. This signalling may be performed without the UE 901 having performed a RACH procedure to the first source DU 902 between receiving the cell switch trigger signalling of 9011 and performing 9012.

In this example of FIG. 9, the UE is provided with an indication in the cell switch command that indicates that the UE may use the same TA value that the UE has stored for the source cell.

In particular, the UE may send the TA value(s) along with the associated valid TAG-ID(s) to its currently RRC connected cell. The source DU may send the TA values to the target DU after the cell switch command has been signalled to the UE. In case UE needs to go back to the source cell, the target DU may include the TA value associated with the source DU (given that the TAG-ID is still valid at the UE) in the cell switch command.

The cell switch decision at the source DU may take both L1 measurements and valid TAG-ID indicator into account for the selection of the target cell. For example, a candidate target cell may be preferred for the cell switch if it satisfies the minimum L1 measurement quality, and also has a valid TAG-ID instead of another candidate target cell which satisfies the minimum L1 measurement quality but does not have a valid TAG-ID.

As a variation, the UE may send the TA value(s) along with the associated valid TAG-ID(s) to its currently RRC connected cell (which is provided by a “current” DU). Then, after the cell switch decision at the current DU, the current DU may include the TA value associated with the selected DU providing the cell to which the UE is to switch to (provided that the TAG-ID is still valid at the UE) in the cell switch command.

Network based solution for TA maintenance across LTM cells may therefore involve at least one of a plurality of different parts.

For example, a DU may maintain a Timing-advance and Reference Signal Received Power (RSRP) at the time of exit of a first cell when LTM switching happens to switch a UE from the first cell to a second cell provided by another DU. From the second cell, the another DU can trigger TA acquisition for the first cell when a reported L1-measurement value is different from the RSRP exit value by more than a threshold amount. This may be referred to as a radio-condition based TA re-acquisition for non-serving-cell. Otherwise, the another DU may start a TA validity timer for the first cell.

The another DU may maintain associated sets of timing advance, radio conditions (e.g., RSRP), and timing advance timer values for LTM cells that are being considered during mobility. An entry (e.g., a single associated set of values) may be deleted when the new serving cell is not receiving the report for the cell or when the reported value is lower than specific threshold. Deleting entries may be useful for avoiding maintaining the TA value for cells which are not potential candidate for immediate switching based on measurements.

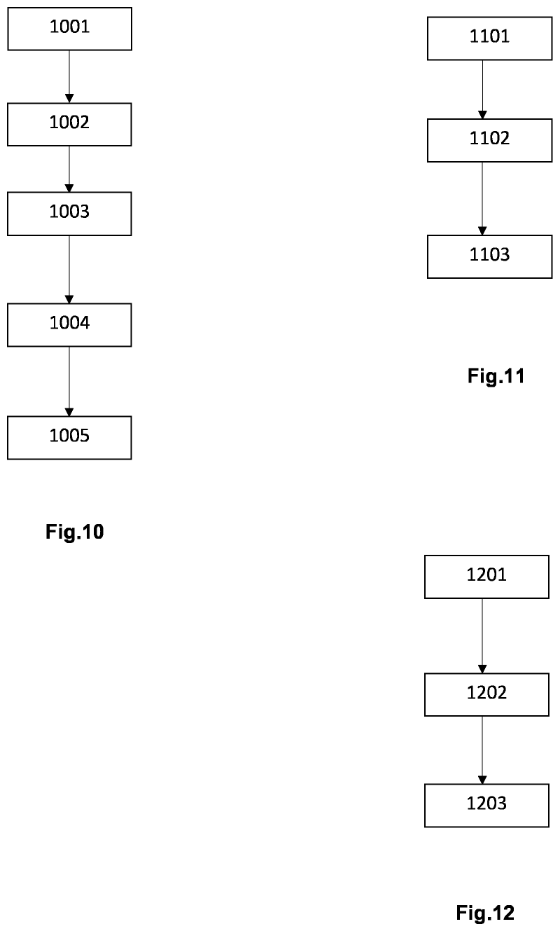

FIGS. 10 to 12 illustrate operations that may be performed by apparatus described herein, and reflect features described above in relation to FIGS. 8 and 9. It is therefore understood that features from FIGS. 8 and 9 may be incorporated into the following operations. It is further understood that objects and entities described below in relation to any of FIGS. 10 to 12 may be used to clarify objects and entities described in others of FIGS. 10 to 12.

FIG. 10 illustrates operations that may be performed by an apparatus for a first access network node. The first access network node may be a DU.

During 1001, the apparatus receives, from the user equipment via a first cell provided by the first access network node, a measurement report comprising an indication of a signal quality associated with a second cell provided by a second access network node. The measurement report may be an L1 measurement report, although it is understood that this is not necessarily the case. The second cell may comprise a candidate cell and/or a serving cell.

During 1002, the apparatus determines, based on the measurement report, to instruct the user equipment to connect to the second cell. The connecting may comprise switching from the first cell to the second cell (e.g., during a handover operation). The connecting may comprise using the second cell as an additional cell to the first cell (e.g., such that the UE is simultaneously connected to the first cell and the second cell, such as during cell aggregation and/or dual connectively).

During 1003, the apparatus determines whether a second timing advance value associated with the second access network node is valid.

During 1004, the apparatus determines whether to instruct the user equipment to connect to the second cell without obtaining a new timing advance value for the second access network node when the second timing advance value is determined to be valid, or to instruct the user equipment to connect to to the second cell with obtaining a new timing advance value when the second timing advance value is determined to be invalid. The user equipment may obtain a new timing advance value using a random access procedure (e.g., in response to a RACH preamble being signalled from the UE). The user equipment may abstain from obtaining a new timing advance value by not initiating a random access procedure prior to signalling RRC signalling to the second cell.

During 1005, the apparatus instructs the user equipment in accordance with the determining whether to instruct.

Information regarding whether the second timing advance value is valid may be received from the user equipment and/or from another network node (such as, for example, another DU and/or a CU).

For example, the determining whether the second timing advance value is valid comprise receiving, from the user equipment, a second timing advance group identifier with the indication of the signal quality associated with the second cell, the second timing advance group identifier being associated with a second set of cells having a same second timing advance value, the second set of cells comprising the second cell, and determining whether the second timing advance value is valid using the second timing advance group identifier.

Determining that the second timing advance value is valid may comprise receiving, from the user equipment, an indication of whether the second timing advance group identifier is valid, and determining whether the second timing advance value is valid using the received indication of whether the second timing advance group identifier is valid. The indication may be an explicit indication.

The determining whether the second timing advance value is valid may comprise receiving, from another network node (e.g., a DU and/or a CU), a second timing advance group identifier and an indication of a duration of time for which the second timing advance value is valid, the second timing advance group identifier being associated with a second set of cells having a same second timing advance value, the second set of cells comprising the second cell, and using the duration of the time to determine whether the second timing value is valid. The apparatus may initialize a timer using the indicated duration on receipt of the indication of the duration, and start the timer. The apparatus may discard the second timing advance value (or otherwise consider the second timing advance value to be invalid) upon expiry of the timer. The another network node may be the second access network node.

The apparatus may signal an indication of the second timing advance value to the user equipment.

The first access network node may be associated with a first timing advance group identifier being associated with a first set of cells having a same first timing advance value, wherein the first set of cells comprises the first cell.

The first cell may be a serving cell and the second cell is a candidate cell.

The apparatus may provide a plurality of first cells. The apparatus may associate each of the plurality of first cells with a timing advance value for the user equipment. The apparatus may group the plurality of first cells into different groups such that each group is associated with a same timing advance value. The apparatus may assign each of the different groups a respective identifier.

The apparatus may signal, to a centralized unit, a mapping that indicates a correspondence between a respective identifier and its associated timing advance value. The apparatus may receive, from the centralized unit, an instruction to change a respective identifier associated with a specified timing advance value. The apparatus may change the identifier associated with the specified timing advance value. In this way, the apparatus may enable cells provided by different access network nodes that have the same timing advance to be associated with a same timing advance group identifier.

FIG. 11 illustrates operations that may be performed by an apparatus for a network node. The network node may be a distributed unit. The network node may be a centralized unit.

During 1101, the apparatus determines a second timing advance group identifier that is associated with a second set of cells having a same second timing advance value, at least one cell of the second set of cells being provided by a second access network node.

During 1102, the apparatus determines a duration of validity of the second timing advance value.

During 1103, the apparatus signals the duration of validity to another network node. When the network node is a centralized unit and the another network node is a first access network node, the apparatus may configure the second timing advance group identifier at a second access network node, and configure a first timing advance group identifier at the first access network node, the first timing advance group identifier being associated with a first set of cells having a same first timing advance value, at least one cell of the first set of cells being provided by the first access network node.

The apparatus may receive, from the second access network node, a mapping that indicates a correspondence between a respective identifier of a group of second cells provided by the second access network node and its associated timing advance value; receive, from a first access network node, a mapping that indicates a correspondence between a respective identifier of a group of first cells provided by the first access network node and its associated timing advance value; determine whether the timing advance values received are the same, and instruct the first and/or second access network node to change its respective identifier to be identical with the respective identifier of the other access network node when the timing advance values are determined to be the same. In this way, the apparatus may enable cells provided by different access network nodes that have the same timing advance to be associated with a same timing advance group identifier.

The network node may be a first access network node and the another network node may be a centralized unit.

The apparatus may signal a first mapping to a user equipment, the first mapping associating a first cell provided by a first access network node to a first timing advance group identifier, the first timing advance group identifier being associated with a first set of cells having a same first timing advance value, the first set of cells comprising the first cell, and signal a second mapping to the user equipment, the second mapping associating a second cell provided by the second access network node to a second timing advance group identifier, the second timing advance group identifier being associated with a second set of cells having a same second timing advance value, the second set of cells comprising the second cell.

The second set of cells may comprise a candidate cell.

FIG. 12 illustrates operations that may be performed by an apparatus for a user equipment, the user equipment.

During 1201, the user equipment signals a measurement report to a first network access node via a first cell, the measurement report comprising an indication of a signal quality associated with a second cell provided by a second access network node.

During 1202, the user equipment receives an instruction to connect to the second cell, the second cell being provided by a second network access node, wherein the instruction indicates whether the user equipment is to switch to the second cell with or without obtaining a new timing advance value.

During 1203, the user equipment connects to the second cell in accordance with the received instruction.

The user equipment may signal the indication of the signal quality associated with the second cell with a second timing advance group identifier, the second timing advance group identifier being associated with a second set of cells having a same second timing advance value, the second set of cells comprising the second cell.

The user equipment may signalling an indication of whether that the second timing advance group identifier is valid with the measurement report.

The user equipment may receive a first mapping, the first mapping associating the first cell to a first timing advance group identifier, the first timing advance group identifier being associated with a first set of cells having a same first timing advance value, the first set of cells comprising the first cell, and receive a second mapping, the second mapping associating the second cell to a second timing advance group identifier, the second timing advance group identifier being associated with a second set of cells having a same second timing advance value, the second set of cells comprising the second cell.

Connecting to the second cell may comprise switching from the first cell to the second cell.

The first cell may be a serving cell and the second cell may be a candidate cell.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

For example, although the above examples are provided in the context of inter-DU cell switches, analogous signalling may be performed for inter-CU cell switching.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software code, logic or any combination thereof. For example, some aspects may be implemented in hardware, while other aspects may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 10, and/or FIG. 11 and/or FIG. 12, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” or “means” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to a limitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further implementation comprising a combination of one or more implementations with any of the other implementations previously discussed.

1-31. (canceled)

32. An apparatus for a first access network node, the apparatus comprising at least one processor; and
at least one memory comprising executable instructions that, when executed by the at least one processor, cause the apparatus at least to:
receive, from a user equipment via a first cell provided by the first access network node, a measurement report comprising an indication of a signal quality associated with a second cell provided by a second access network node;
determine, based on the measurement report, to instruct the user equipment to connect to the second cell;
determine whether a second timing advance value associated with the second access network node is valid;
determine whether to instruct the user equipment to connect to the second cell without obtaining a new timing advance value for the second access network node when the second timing advance value is determined to be valid, or to instruct the user equipment to connect to the second cell with obtaining a new timing advance value when the second timing advance value is determined to be invalid; and
instructing the user equipment in accordance with the determining whether to instruct.

33. An apparatus as claimed in claim 32, wherein the determining whether the second timing advance value is valid comprises:
receive, from the user equipment, a second timing advance group identifier with the indication of the signal quality associated with the second cell, the second timing advance group identifier being associated with a second set of cells having a same second timing advance value, the second set of cells comprising the second cell; and
determine whether the second timing advance value is valid using the second timing advance group identifier.

34. An apparatus as claimed in claim 32, wherein determining that the second timing advance value is valid comprises:
receive, from the user equipment, an indication of whether the second timing advance group identifier is valid; and
determine whether the second timing advance value is valid using the received indication of whether the second timing advance group identifier is valid.

35. An apparatus as claimed in claim 32, wherein the determining whether the second timing advance value is valid comprises:
receive, from another network node, a second timing advance group identifier and an indication of a duration of time for which the second timing advance value is valid, the second timing advance group identifier being associated with a second set of cells having a same second timing advance value, the second set of cells comprising the second cell; and
use the duration of the time to determine whether the second timing value is valid.

36. An apparatus as claimed in claim 32, further comprising:
providing a plurality of first cells;
associating each of the plurality of first cells with a timing advance value for the user equipment;
grouping the plurality of first cells into different groups such that each group is associated with a same timing advance value; and
assigning each of the different groups a respective identifier.

37. An apparatus as claimed in claim 36, further comprising:
signalling, to a centralized unit, a mapping that indicates a correspondence between a respective identifier and its associated timing advance value.

38. An apparatus as claimed in claim 37, further comprising:
receiving, from the centralized unit, an instruction to change a respective identifier associated with a specified timing advance value; and
changing the identifier associated with the specified timing advance value.

39. An apparatus for a user equipment, the apparatus comprising at least one processor; and
at least one memory comprising executable instructions that, when executed by the at least one processor, cause the apparatus at least to:
signal a measurement report to a first network access node via a first cell, the measurement report comprising an indication of a signal quality associated with a second cell provided by a second access network node;
receive an instruction to connect to the second cell, the second cell being provided by a second network access node, wherein the instruction indicates whether the user equipment is to connect to the second cell with or without obtaining a new timing advance value; and
connect to the second cell in accordance with the received instruction.

40. An apparatus as claimed in claim 39, further comprising: signalling the indication of the signal quality associated with the second cell with a second timing advance group identifier, the second timing advance group identifier being associated with a second set of cells having a same second timing advance value, the second set of cells comprising the second cell.

41. An apparatus as claimed in claim 39, further comprising signalling an indication of whether that the second timing advance group identifier is valid with the measurement report.

42. An apparatus as claimed claim 39, further comprising:
receiving a first mapping, the first mapping associating the first cell to a first timing advance group identifier, the first timing advance group identifier being associated with a first set of cells having a same first timing advance value, the first set of cells comprising the first cell; and
receiving a second mapping, the second mapping associating the second cell to a second timing advance group identifier, the second timing advance group identifier being associated with a second set of cells having a same second timing advance value, the second set of cells comprising the second cell.

43. An apparatus as claimed in claim 39, wherein connecting to the second cell comprises switching from the first cell to the second cell.

44. An apparatus as claimed in claim 39, wherein the first cell is a serving cell and the second cell is a candidate cell.
